(19) United States
(12) Patent Application Publication
(10) Pub. No.: US 2009/0183064 A1
(43) Pub. Date: Jul. 16, 2009

(54) Data Entry Apparatus And Method

(76) Inventors: Shekhar Ramachandra BORGAONKAR, Bangalore (IN); Prashanth ANANT, Bangalore (IN); Praphul CHANDRA, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/325,761

(22) Filed: Dec. 1, 2008

(30) Foreign Application Priority Data
Jan. 14, 2008 (IN) 130/CHE/2008

(51) Int. Cl. G06F 17/21

(52) U.S. Cl. 715/224

(57) ABSTRACT

Apparatus such as a PDA with screen can be used to enter data in cooperation with a physical form. The method may include identifying a part of a form on which the apparatus is placed as part of a form stored in the apparatus and displaying a corresponding image. Data may be entered, for example using a touch screen, and both displayed on the screen in the corresponding form and stored in a corresponding data record.

### BACKGROUND OF THE INVENTION

There are many applications where it is necessary to collect data. The most familiar way in which data can be collected and dealt with is the traditional paper form. Such forms may conveniently be filled in both in an office environment and away from an office. However, after the form is filled in, there is normally a need to transfer the data into a database, which normally requires human input.

For this reason, it has become normal to enter data directly into a computer database.

However, this can be inconvenient, especially when entering data in the field, that is to say outside the office environment. In particular, it can be inconvenient to enter large amounts of data, corresponding to large forms, on a small handheld device which frequently will not have a conventional keyboard.

A further inconvenience is that navigation can be difficult when significant amounts of data need to be entered, but the data is not always provided in the order anticipated. This means that it is not possible to simply request the data in a predetermined order, and accept inputs to questions one after another. Instead, it is necessary to enter data into data fields in a random order provided by the data subject.

There thus remains a need for a convenient data entry device that can readily cope with entering data in any required order.

### BRIEF DESCRIPTION OF THE DRAWINGS

For a better understanding of the invention, embodiments will now be described, purely by way of example, with reference to the accompanying drawings, in which:

FIG. 1 shows a first embodiment in front view;

FIG. 2 shows the first embodiment in side view in use;

FIG. 3 is a block diagram illustrating the first embodiment;

FIG. 4 shows a flow diagram of a method according to a first embodiment;

FIG. 5 illustrates use of the first embodiment;

FIG. 6 shows a second embodiment in side view;

FIG. 7 illustrates use of the second embodiment;

FIG. 8 shows a third embodiment; and

FIG. 9 illustrates use of the third embodiment.

The figures are schematic and not to scale. Like or similar components are given the same reference numerals in different figures, and the description relating to the components indicated in this way is not repeated.

### DETAILED DESCRIPTION OF THE INVENTION

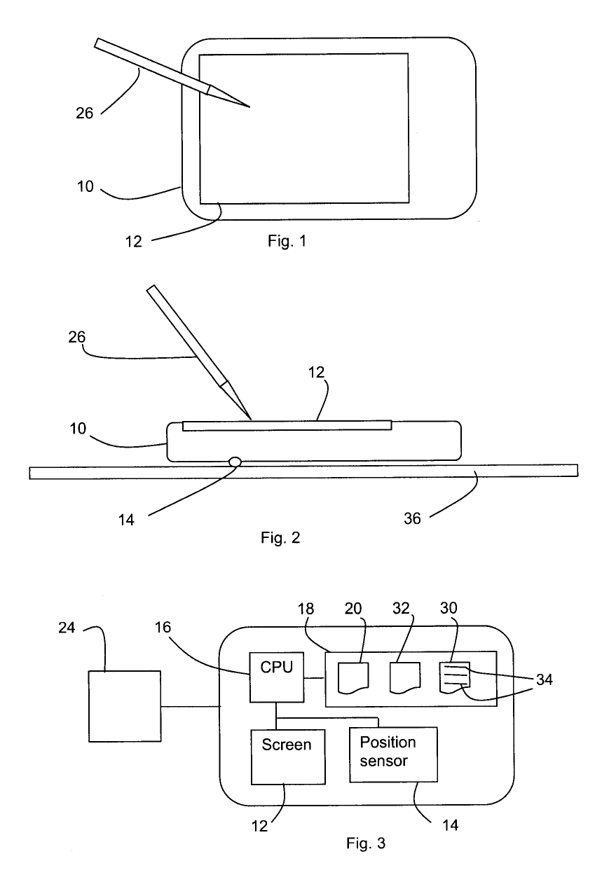

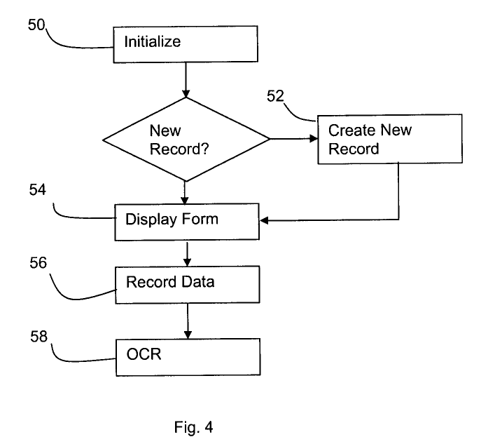

Referring to FIGS. 1 to 3, an embodiment of the invention includes a personal data assistant (PDA) 10, with a front screen 12. The front screen is a touch sensitive screen capable of data entry, for example using a separate stylus 26. On the rear of the PDA, i.e. on the surface opposite the front screen 12, is an position sensor 14, in the embodiment an optical mouse.

The PDA also includes a central processing unit 16 and a memory 18, storing both code 20 and other data 30,32.

The PDA can be connected to a separate scanner 24 for more convenient scanning of documents.

The code 20 is arranged to make the PDA carrying out the steps mentioned below when run on the PDA central processing unit. In particular, the method of use will now be described with reference to FIGS. 2 and 3.

One or more database records 30 and corresponding image forms 32, also known as a stored form 32, are stored in memory 18. The database record 30 has a number of fields 34 for storing information. These correspond to some or all of the data entry fields 38 on the image form 32. The image form 32 in the embodiment is an image of a paper form 36, together with electronic links between parts of the image related to particular data on the form, i.e. the data entry fields 38 and the respective fields 34 in the database records 30. The paper form 36 is one example of a physical form, i.e. a form in tangible form rather than an electronic image or database record.

The image forms 32 may be prepared by scanning in the paper forms using separate scanner 24 and then processing the forms in software either in the scanner 24, the PDA 10, or in a separate computer (the latter not shown). The image form is then completely loaded into the PDA 10.

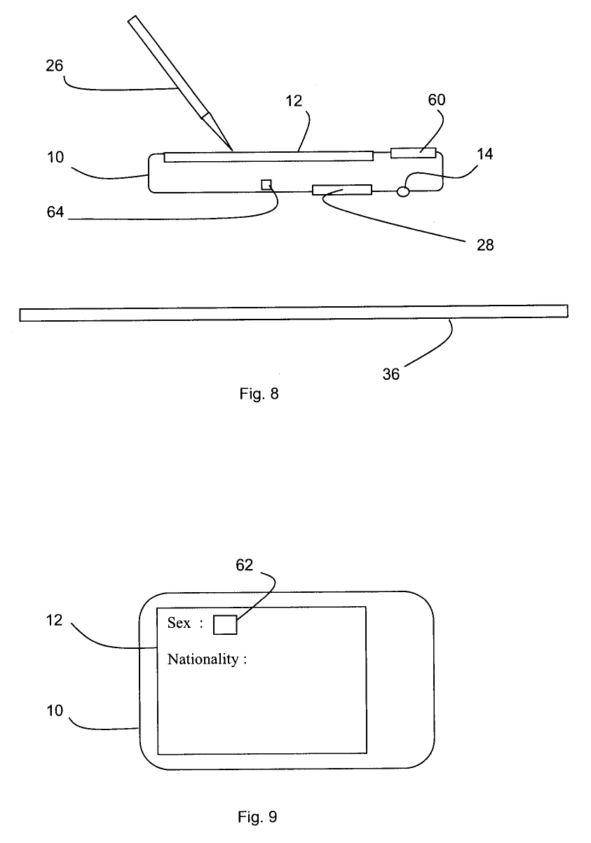

In the field, the user places the PDA 10 over the paper form 36. The form is identified, for example by user input, and the PDA aligned with a predetermined location on the form, for example the top left. (step 50). Guide marks may be printed on the form to identify this location, or alternatively the PDA may simply be aligned with the top left of the form (FIG. 8). The initial position of the PDA with respect to the form is stored as initial position data.

If a new instance of form 36 is being processed, a new database record 30 is created. If alternatively a record corresponding to the image of the form already exist, an old record is accessed.

In the embodiment, when a form is identified, the user is given the option of opening an old instance of a record of the form or creating a new record. Thus, the user only needs one paper copy of each form and can electronically fill it in many times.

Thus, if necessary, a new record 30 is created for a new instance of the form (step 52).

As the user moves the PDA 10 over the paper form 36 the position data is updated based on signals from the position sensor 14 processed by the code 20.

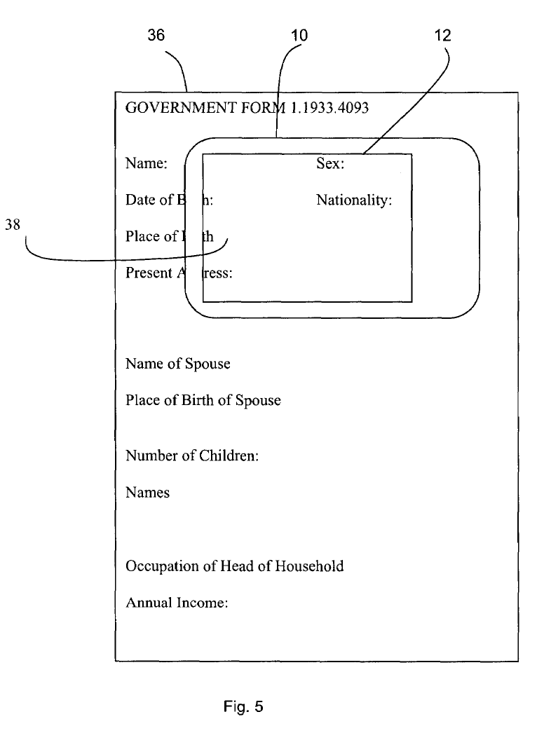

The electronic image of the part of the paper form 36 under the PDA 10 is displayed on screen 12 (step 54) using the identified form and the position data. This is illustrated in FIG. 5. Thus, referring to this Figure, the words “Sex” and “Nationality” are displayed on the screen 12 over the corresponding words on paper form 36.

Thus, the screen simply displays the content under the PDA 10.

Next, the user can use the stylus 26 and enter data in a data entry field 38 of the displayed image form 32. The corresponding data field 34 of a corresponding record 30 is then updated with the entered data (step 56). The data entered may be stored both as an image, for display in the relevant part of the image form, and also optical character read (step 58) to store the data also in machine readable form.

The user moves the PDA over the form 36. The motion is sensed by the position sensitive device and updates the position data to track the position of the PDA over the paper form 36 at any time. The screen updates and displays the text under the PDA on the form 36 and enters data in the required data fields, updating the corresponding fields 34 of corresponding record 30.

In this way, a user can electronically fill in forms simply using a PDA 10 and paper forms 36. This greatly eases field data collection, where multiple page forms may need to be filled in in a location that does not provide the normal convenience of the office. The data entered into the forms is directly entered into electronic records.

Note that the user can easily enter data in any order, simply by moving the PDA over the correct region for the new data. Thus, data presented by a data subject who presents the data not in the order given on the form can more readily be entered.

The form can be navigated easily simply by moving the PDA over the relevant parts of the paper form. This renders navigation around the form very straightforward even for personnel who are not familiar with computers or PDAs.

The navigation allows the perspective of a large piece of paper, which is easy to transport to remote locations, and without the expense of requiring a large portable screen which may be prohibitive. The context of the data being entered may be readily seen.

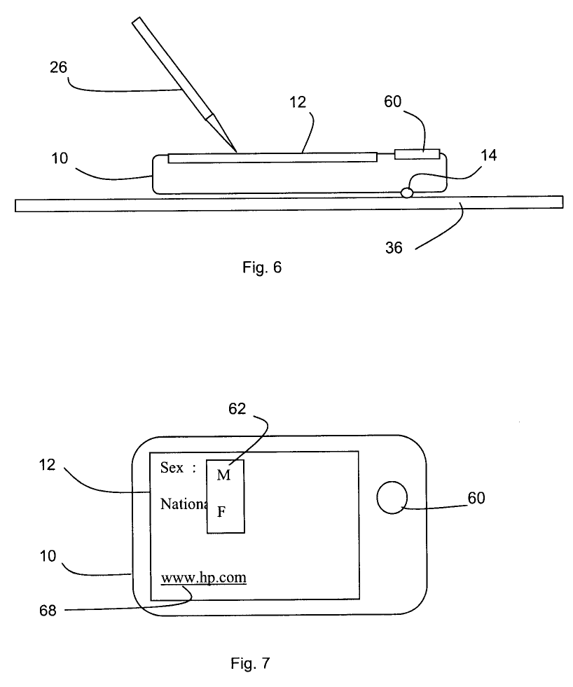

FIG. 6 shows a further embodiment with additional functionality.

Firstly, the embodiment has a magnification or zoom control 60 for zooming the electronic image form 32 to increase the size of a particular region for greater ease in entering data. This control 60 cooperates with the code so that operation of the control zooms in or out as required.

A second additional functionality is a menu control 62 displayed on the electronic image form 32 displayed on front screen 12. When the user taps the stylus on menu control 62, a drop down menu is displayed on the front screen 12, as illustrated in FIG. 7. The user then selects one of the items (M or F in the example) in the drop down menu to add the item to the field at that location. Note that the drop down menu of menu control 62 is displayed over the text otherwise at that location.

In the event that none of the items in the drop down menu is suitable, in some fields the user may be allowed to write in the data. For other fields, for which only the items in the drop down menu are possible, this option may not be made available.

As the user moves the PDA over already filled in fields, the data already entered is displayed. Optionally, the display may display the data written in or the data as interpreted by the optical character reader.

In a modification of the embodiment, the electronic image may include hyperlinks 68 to additional information, for example available over the world wide web or an intranet. The hyperlink may be actuated by simply tapping on the link on the screen where displayed using the stylus 26.

In a third embodiment, illustrated in FIG. 8, the scanner 14 of the second embodiments may be replaced by a camera 64. In this case, an image of the form from a distance is used to identify the form. The PDA is then aligned with the form by placing the PDA on a specific location on the form.

Then, motion of the PDA over the form is tracked using the position sensor 14 as in the first embodiment.

Alternatively, the camera 64 may be replaced by an integral scanner 28 which scans the form and hence identifies it. Accordingly, in the case of this arrangement, the user does not need to identify the form and input the identity of the form but this is done automatically. Note that either or both of scanner 28 and camera 64 might be used for this function.

While specific embodiments have been described herein for purposes of illustration, various modifications will be apparent to a person skilled in the art and may be made without departing from the scope of the invention. Accordingly, the invention is not limited to the above-described implementations, but instead is defined by the appended claims in light of their full scope of equivalents.

For example, although the form 36 is referred to above as a paper form it may be on a different tangible medium, and hence may be any other physical form.

The position sensor need not be an optical mouse, but other position sensors such as a tracker ball or sound-sensor based technologies may also be used.

The position sensing may also be carried out optically, for example using an integrated scanner 28 to detect motion over the page.

Although in the described embodiment OCR on the entered data is carried out by the PDA 10 this is not essential and the entered data can simply be entered as an image and processed later.

The use of the term “PDA” should not be thought of as limiting and the invention can be implemented with any convenient apparatus, especially handheld and/or portable apparatus.

The term data is used in its widest sense to mean any form of data that may be captured.

We claim:

1. Apparatus for data entry, comprising:
a screen;
a position location device; and
code arranged to identify a form on which the apparatus is placed and display an image of part of the stored form on the screen including any data entry fields in the said part of the form, to detect motion of the apparatus for data entry over the form using the position location device and to update the displayed image based on the motion, and to capture data entered into a displayed data entry field.

2. Apparatus according to claim 1, wherein the screen is a touch screen acting as a data entry module to allow data to be entered.

3. Apparatus according to claim 1 wherein the displayed image of the said part of the stored form is a simple representation of a physical form on which the apparatus is placed so that the displayed image simply shows the part of the physical form under the apparatus.

4. Apparatus according to claim 1, further comprising a data entry control for display in a data entry field, wherein the code is arranged to display a number of options when the data entry control is selected and to capture a selected one of the options as the data entered into the corresponding data record.

5. Apparatus according to claim 1, wherein the data entry module is a touch sensor integrated in the screen, the code being further adapted to carry out optical character recognition to interpret the data entered on the displayed data entry field and to store the interpreted data in the corresponding data record.

6. A method for data entry using apparatus, comprising:
identifying a form on which the apparatus is placed as a stored form stored in the apparatus;
displaying an image including any corresponding data entry fields of the part of the stored form corresponding to the part of the form on which the apparatus is placed;
detecting motion of the apparatus over the form and updating the displayed image accordingly;
capturing data entered into a displayed data entry field and storing the entered data in a data record.

7. A method according to claim 6 comprising displaying as the displayed image of the said part of the stored form a simple representation of the physical form on which the apparatus is placed so that the displayed image simply shows the part of the physical form under the apparatus.

8. A method according to claim 6, further comprising detecting motion of the apparatus over the form using the position locating device and updating the displayed part of the form using the detected motion.

9. A method according to claim 6, further comprising
displaying a data entry control in a data entry field,
on user input selecting the data entry control, displaying a number of options; and
capturing a selected one of the options and entering data corresponding to the selected option into the corresponding data record.

10. A method according to claim 6 further comprising carrying out optical character recognition to interpret the data entered in the displayed data entry field and storing the interpreted data in the corresponding data record.

11. A computer program product stored on a data carrier arranged to cooperate with a portable computing apparatus, including code:
to identify a physical form on which the portable computing apparatus is placed;
to display an image of a part or all of the stored form including any data entry fields in the said part of the form;
to detect motion of the apparatus for data entry over the form and to update the displayed image accordingly; and
to capture data entered into a displayed data entry field and to store the entered data in a database.
